(19) United States
(12) Patent Application Publication
(10) Pub. No.: US 2009/0187950 A1
(43) Pub. Date: Jul. 23, 2009

(54) AUDIBLE MENU SYSTEM

(75) Inventors: Nicholas A. Nicas, Blue Springs, MO (US); Christopher R. Heck, Lees Summit, MO (US); James Huffman, Kansas City, MO (US)

Correspondence Address: AT&T Legal Department - JW;Attn: Patent Docketing, Room 2A-207, One AT&T Way, Bedminster, NJ, 07921, US

(73) Assignee: AT&T Knowledge Ventures, L.P., Reno, NV (US)

(21) Appl. No.: 12/016,776

(22) Filed: Jan. 18, 2008

(51) Int. Cl. H04N 5/445

(52) U.S. Cl. 725/56

(57) ABSTRACT

An audible menu system associated with distribution of television content over a service provider network is disclosed. The menu system includes a speech synthesizer and screen reader. Electronic programming guide (EPG) elements are read by a screen reader and provided to a speech synthesizer for presenting audible representations of EPG elements to a user. The user may provide inputs to a remote control device to navigate an EPG that may also be presented through a graphical user interface. As a user navigates a cursor over selectable EPG elements, disclosed embodiments provide audible outputs that correspond to the selectable EPG elements. In some embodiments, users may provide customized audio inputs that are played as audio outputs during future menu navigation sessions.

### BACKGROUND

1. Field of the Disclosure

The present disclosure generally relates to distribution of digital television content and more particularly to menu systems for selecting multimedia programs.

2. Description of the Related Art

Many households contain televisions that are communicatively coupled to set-top boxes for receiving multimedia content from provider networks. When selecting multimedia content, a user may be presented with a visual menu system with selectable icons, for example. Individuals who are visually impaired, illiterate, or learning disabled may have difficulty with such visual-based menu systems.

### BRIEF DESCRIPTION OF THE DRAWINGS

FIG. 1 is a block diagram of selected elements of a multimedia content distribution network;

FIG. 2 is a block diagram of selected elements of a set-top box suitable for use in the network of FIG. 1;

FIG. 3 depicts a remote control device;

FIG. 4 depicts elements of a set-top box of FIG. 2 for providing an audible menu system; and

FIG. 5 is a flow diagram representing selected elements of a method of providing an audible menu system.

### DESCRIPTION OF THE EMBODIMENT(S)

In one aspect, a set-top box (STB) is disclosed for providing an audible menu system. The STB includes a screen reader for reading a plurality of electronic programming guide (EPG) elements. The STB further includes a speech synthesizer for providing a plurality of audio outputs indicative of a portion of the plurality of EPG elements. In some embodiments, the screen reader is enabled for providing a plurality of audio outputs indicative of the location of a cursor on a display. The STB may include an output jack for providing audio signals. In addition, the STB may include a storage and an input jack for receiving audible inputs for associating with selected of the plurality of EPG elements. Data indicative of the audible inputs may be stored in the storage. Embodied STBs may also include a speaker for providing audible sounds corresponding to the plurality of audio outputs. The STB may also have a hardware interface for receiving signals indicative of user inputs, and further be enabled for producing audible sounds indicative of user inputs received from the hardware interface.

In another aspect, a computer program product is provided on a computer readable medium for providing an audible menu system. The computer program product includes instructions operable for receiving a plurality of inputs indicative of a corresponding plurality of electronic programming guide elements. In some embodiments, further instructions are for providing a plurality of inputs indicative of a corresponding plurality of EPG elements. Additionally, instructions may be further operable for providing a plurality of synthesized speech sounds corresponding to the plurality of inputs in response to user inputs. Audible verifications of user inputs may be provided related to the position of the cursor. Further instructions may be operable for providing audio outputs indicative of the location of a cursor on a display. Instructions may be operable for encoding audio signals corresponding to the plurality of audio outputs, wherein the audio signals are for an output jack. Additionally, instructions may be operable for storing data indicative of received audible inputs and for associating a portion of the data with selected of the plurality of EPG elements.

In still another aspect, a method is disclosed for providing an audible menu system. The method includes receiving a plurality of inputs indicative of a corresponding plurality of EPG elements. The method may further include providing a plurality of synthesized speech sounds corresponding to the plurality of audible outputs, wherein providing the plurality of synthesized speech sounds is in response to user inputs. Verification sounds may be provided to verify the position of the cursor over a selectable icon. The selectable icon may be a text box containing a program identifier. The method may further include providing audio outputs indicative of the location of a cursor on a display. Additionally, the method may include encoding audio signals that correspond to the plurality of inputs, wherein the audio signals are for providing to an output jack. In some embodiments, the method includes storing data indicative of received audible inputs and associating a portion of the data with selected of the plurality of EPG elements. The method may further include processing user input signals received at the hardware interface and producing audible signals indicative of the received user inputs.

In the following description, details are set forth by way of example to provide a thorough explanation of the disclosed subject matter. It should be apparent to a person of ordinary skill, however, that the disclosed embodiments are exemplary and not exhaustive of all possible embodiments. Throughout this disclosure, in some instances a hyphenated form of a reference numeral refers to a specific instance of an element and the un-hyphenated form of the reference numeral refers to the element generically or collectively. Thus, for example, element “102-1” refers to an instance of an element class, which may be referred to collectively as elements “102” and any one of which may be referred to generically as an element “102”.

Menu systems related to multimedia content (e.g., television programming) are common and often require a user to have good eyesight to operate them. For example, some menu systems have selectable icons that a user manipulates with an on-screen cursor using directional inputs from a remote control unit. For users that are visually impaired, it may be difficult to manipulate an on-screen cursor over a selectable icon.

Before describing details of applications and systems used in conjunction with a multimedia content distribution network, selected aspects of the network and selected devices used to implement the network are described to provide context for at least some implementations.

Television programs, video-on-demand, radio programs including music programs, and a variety of other types of multimedia content may be distributed to multiple subscribers over various types of networks. Suitable types of networks that may be configured to support the provisioning of multimedia content services by a service provider include, as examples, telephony-based networks, coaxial-based networks, satellite-based networks, and the like.

In some networks including, for example, traditional coaxial-based “cable” networks, whether analog or digital, a service provider distributes a mixed signal that includes a relatively large number of multimedia content channels (also referred to herein as “channels”), each occupying a different frequency band or channel, through a coaxial cable, a fiber-optic cable, or a combination of the two. The enormous bandwidth required to transport simultaneously large numbers of multimedia channels is a source of constant challenge for cable-based providers. In these types of networks, a tuner within a STB, television, or other form of receiver is required to select a channel from the mixed signal for playing or recording. A subscriber wishing to play or record multiple channels typically needs to have distinct tuners for each desired channel. This is an inherent limitation of cable networks and other mixed signal networks.

In contrast to mixed signal networks, Internet Protocol Television (IPTV) networks generally distribute content to a subscriber only in response to a subscriber request so that, at any given time, the number of content channels being provided to a subscriber is relatively small, e.g., one channel for each operating television plus possibly one or two channels for simultaneous recording. As suggested by the name, IPTV networks typically employ Internet Protocol (IP) and other open, mature, and pervasive networking technologies. Instead of being associated with a particular frequency band, an IPTV television program, movie, or other form of multimedia content is a packet-based stream that corresponds to a particular network address, e.g., an IP address. In these networks, the concept of a channel is inherently distinct from the frequency channels native to mixed signal networks. Moreover, whereas a mixed signal network requires a hardware intensive tuner for every channel to be played, IPTV channels can be “tuned” simply by transmitting to a server an IP or analogous type of network address that is associated with the desired channel.

IPTV may be implemented, at least in part, over existing infrastructure including, for example, existing telephone lines, possibly in combination with customer premise equipment (CPE) including, for example, a digital subscriber line (DSL) modem in communication with a STB, a display, and other appropriate equipment to receive multimedia content from a provider network and convert such content into usable form. In some implementations, a core portion of an IPTV network is implemented with fiber optic cables while the so-called last mile may include conventional, unshielded, twisted-pair, copper cables.

IPTV networks support bidirectional (i.e., two-way) communication between a subscriber's CPE and a service provider's equipment. Bidirectional communication allows a service provider to deploy advanced features, such as video-on-demand (VOD), pay-per-view, advanced programming information (e.g., sophisticated and customizable programming guides), and the like. Bidirectional networks may also enable a service provider to collect information related to a subscriber's preferences, whether for purposes of providing preference based features to the subscriber, providing potentially valuable information to service providers, or potentially lucrative information to content providers and others.

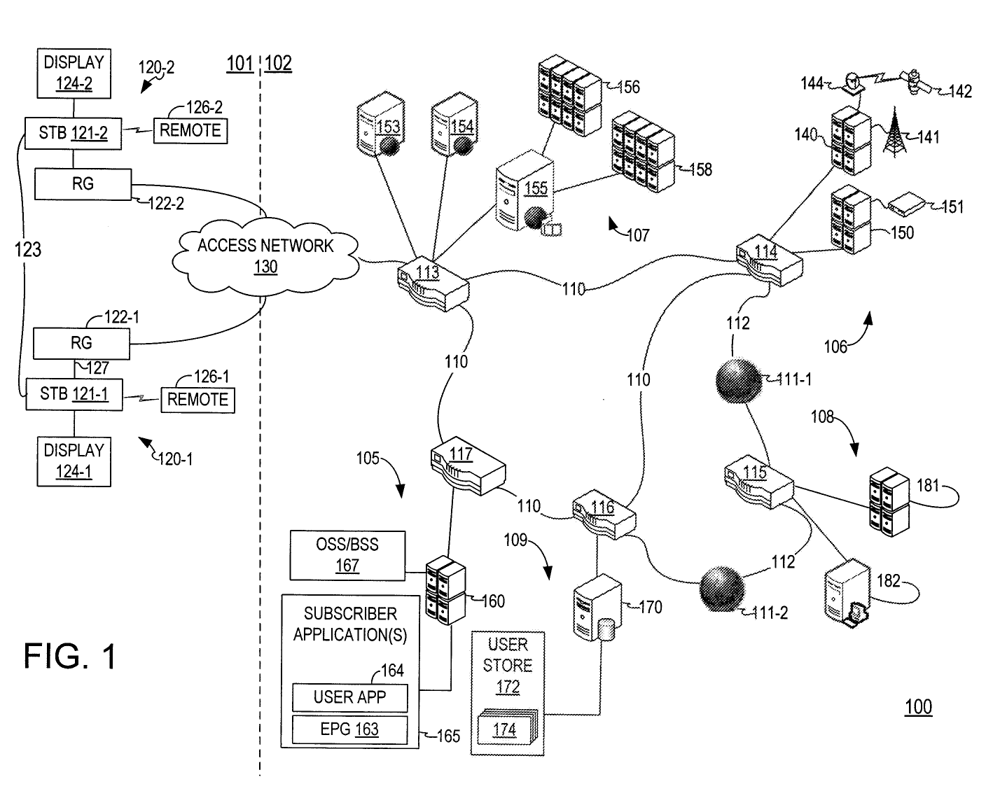

Referring now to the drawings, FIG. 1 illustrates selected aspects of a multimedia content distribution network (MCDN) 100. MCDN 100, as shown, is a provider network that may be generally divided into a client side 101 and a service provider side 102 (a.k.a., server side 102). The client side 101 includes all or most of the resources depicted to the left of access network 130 while the server side 102 encompasses the remainder.

Client side 101 and server side 102 are linked by access network 130. In embodiments of MCDN 100 that leverage telephony hardware and infrastructure, access network 130 may include the “local loop” or “last mile,” which refers to the physical wires that connect a subscriber's home or business to a local exchange. In these embodiments, the physical layer of access network 130 may include twisted pair copper cables or fiber optics cables employed either as fiber to the curb (FTTC) or fiber to the home (FTTH).

Access network 130 may include hardware and firmware to perform signal translation when access network 130 includes multiple types of physical media. For example, an access network that includes twisted-pair telephone lines to deliver multimedia content to consumers may utilize DSL. In embodiments of access network 130 that implement FTTC, a DSL access multiplexer (DSLAM) may be used within access network 130 to transfer signals containing multimedia content from optical fiber to copper wire for DSL delivery to consumers.

In other embodiments, access network 130 may transmit radio frequency (RF) signals over coaxial cables. In these embodiments, access network 130 may utilize quadrature amplitude modulation (QAM) equipment for downstream traffic. In these embodiments, access network 130 may receive upstream traffic from a consumer's location using quadrature phase shift keying (QPSK) modulated RF signals. In such embodiments, a cable modem termination system (CMTS) may be used to mediate between IP-based traffic on private network 110 and access network 130.

Services provided by the server side resources as shown in FIG. 1 may be distributed over a private network 110. In some embodiments, private network 110 is referred to as a “core network.” In at least some embodiments, private network 110 includes a fiber optic wide area network (WAN), referred to herein as the fiber backbone, and one or more video hub offices (VHOs). In large scale implementations of MCDN 100, which may cover a geographic region comparable, for example, to the region served by telephony-based broadband services, private network 110 includes a hierarchy of VHOs.

A national VHO, for example, may deliver national content feeds to several regional VHOs, each of which may include its own acquisition resources to acquire local content, such as the local affiliate of a national network, and to inject local content such as advertising and public service announcements from local entities. The regional VHOs may then deliver the local and national content for reception by subscribers served by the regional VHO. The hierarchical arrangement of VHOs, in addition to facilitating localized or regionalized content provisioning, may conserve bandwidth by limiting the content that is transmitted over the core network and injecting regional content “downstream” from the core network.

Segments of private network 110, as shown in FIG. 1, are connected together with a plurality of network switching and routing devices referred to simply as switches 113 through 117. The depicted switches include client facing switch 113, acquisition switch 114, operations-systems-support/business-systems-support (OSS/BSS) switch 115, database switch 116, and an application switch 117. In addition to providing routing/switching functionality, switches 113 through 117 preferably include hardware or firmware firewalls, not depicted, that maintain the security and privacy of network 110. Other portions of MCDN 100 communicate over a public network 112, including, for example, the Internet or other type of web-network where the public network 112 is signified in FIG. 1 by the world wide web icons 111.

As shown in FIG. 1, the client side 101 of MCDN 100 depicts two of a potentially large number of client side resources referred to herein simply as client(s) 120. Each client 120, as shown, includes an STB 121, a residential gateway (RG) 122, a display 124, and a remote control device 126. In the depicted embodiment, STB 121 communicates with server side devices through access network 130 via RG 122.

RG 122 may include elements of a broadband modem such as a DSL modem, as well as elements of a router and/or access point for an Ethernet or other suitable local area network (LAN) 127. In this embodiment, STB 121 is a uniquely addressable Ethernet compliant device. In some embodiments, display 124 may be any National Television System Committee (NTSC) and/or Phase Alternating Line (PAL) compliant display device. Both STB 121 and display 124 may include any form of conventional frequency tuner. Remote control device 126 communicates wirelessly with STB 121 using an infrared (IR) or RF signal.

In IPTV compliant implementations of MCDN 100, the clients 120 are operable to receive packet-based multimedia streams from access network 130 and process the streams for presentation on displays 124. In addition, clients 120 are network-aware systems that may facilitate bidirectional networked communications with server side 102 resources to facilitate network hosted services and features. Because clients 120 are operable to process multimedia content streams while simultaneously supporting more traditional web-like communications, clients 120 may support or comply with a variety of different types of network protocols including streaming protocols such as reliable datagram protocol (RDP) over user datagram protocol/internet protocol (UDP/IP) as well as web protocols such as hypertext transport protocol (HTTP) over transport control protocol (TCP/IP).

The server side 102 of MCDN 100 as depicted in FIG. 1 emphasizes network capabilities including application resources 105, which may have access to database resources 109, content acquisition resources 106, content delivery resources 107, and OSS/BSS resources 108.

Before distributing multimedia content to users, MCDN 100 first obtains multimedia content from content providers. To that end, acquisition resources 106 encompass various systems and devices to acquire multimedia content, reformat it when necessary, and process it for delivery to subscribers over private network 110 and access network 130.

Acquisition resources 106 may include, for example, systems for capturing analog and/or digital content feeds, either directly from a content provider or from a content aggregation facility. Content feeds transmitted via VHF/UHF broadcast signals may be captured by an antenna 141 and delivered to live acquisition server 140. Similarly, live acquisition server 140 may capture down linked signals transmitted by a satellite 142 and received by a parabolic dish 144. In addition, live acquisition server 140 may acquire programming feeds transmitted via high-speed fiber feeds or other suitable transmission means. Acquisition resources 106 may further include signal conditioning systems and content preparation systems for encoding content.

As depicted in FIG. 1, content acquisition resources 106 include a VOD acquisition server 150. VOD acquisition server 150 receives content from one or more VOD sources that may be external to the MCDN 100 including, as examples, discs represented by a DVD player 151, or transmitted feeds (not shown). VOD acquisition server 150 may temporarily store multimedia content for transmission to a VOD delivery server 158 in communication with client-facing switch 113.

After acquiring multimedia content, acquisition resources 106 may transmit acquired content over private network 110, for example, to one or more servers in content delivery resources 107. Prior to transmission, live acquisition server 140 may encode acquired content using, e.g., MPEG-2, H.263, a Windows Media Video (WMV) family codec, or another suitable video codec. Acquired content may be encoded and composed to preserve network bandwidth and network storage resources and, optionally, to provide encryption for securing the content. VOD content acquired by VOD acquisition server 150 may be in a compressed format prior to acquisition and further compression or formatting prior to transmission may be unnecessary and/or optional.

Content delivery resources 107 as shown in FIG. 1 are in communication with private network 110 via client facing switch 113. In the depicted implementation, content delivery resources 107 include a content delivery server 155 in communication with a live or real-time content server 156 and a VOD delivery server 158. For purposes of this disclosure, the use of the term “live” or “real-time” in connection with content server 156 is intended primarily to distinguish the applicable content from the content provided by VOD delivery server 158. The content provided by a VOD server is sometimes referred to as time-shifted content to emphasize the ability to obtain and view VOD content substantially without regard to the time of day or the day of week.

Content delivery server 155, in conjunction with live content server 156 and VOD delivery server 158, responds to user requests for content by providing the requested content to the user. The content delivery resources 107 are, in some embodiments, responsible for creating video streams that are suitable for transmission over private network 110 and/or access network 130. In some embodiments, creating video streams from the stored content generally includes generating data packets by encapsulating relatively small segments of the stored content in one or more packet headers according to the network communication protocol stack in use. These data packets are then transmitted across a network to a receiver (e.g., STB 121 of client 120), where the content is parsed from individual packets and re-assembled into multimedia content suitable for processing by a STB decoder.

User requests received by content delivery server 155 may include an indication of the content that is being requested. In some embodiments, this indication includes an IP address associated with the desired content. For example, a particular local broadcast television station may be associated with a particular channel and the feed for that channel may be associated with a particular IP address. When a subscriber wishes to view the station, the subscriber may interact with remote control device 126 to send a signal to STB 121 indicating a request for the particular channel. When STB 121 responds to the remote control signal, the STB 121 changes to the requested channel by transmitting a request that includes an IP address associated with the desired channel to content delivery server 155.

Content delivery server 155 may respond to a request by making a streaming video signal accessible to the user. Content delivery server 155 may employ unicast and broadcast techniques when making content available to a user. In the case of multicast, content delivery server 155 employs a multicast protocol to deliver a single originating stream to multiple clients. When a new user requests the content associated with a multicast stream, there may be latency associated with updating the multicast information to reflect the new user as a part of the multicast group. To avoid exposing this undesirable latency to the subscriber, content delivery server 155 may temporarily unicast a stream to the requesting subscriber. When the subscriber is ultimately enrolled in the multicast group, the unicast stream is terminated and the subscriber receives the multicast stream. Multicasting desirably reduces bandwidth consumption by reducing the number of streams that must be transmitted over the access network 130 to clients 120.

As illustrated in FIG. 1, a client-facing switch 113 provides a conduit between subscriber side 101, including client 120, and server side 102. Client-facing switch 113, as shown, is so-named because it connects directly to the client 120 via access network 130 and it provides the network connectivity of IPTV services to users' locations.

To deliver multimedia content, client-facing switch 113 may employ any of various existing or future Internet protocols for providing reliable real-time streaming multimedia content. In addition to the TCP, UDP, and HTTP protocols referenced above, such protocols may use, in various combinations, other protocols including, real-time transport protocol (RTP), real-time control protocol (RTCP), file transfer protocol (FTP), and real-time streaming protocol (RTSP), as examples.

In some embodiments, client-facing switch 113 routes multimedia content encapsulated into IP packets over access network 130. For example, an MPEG-2 transport stream may be sent, in which the transport stream consists of a series of 188 byte transport packets, for example. Client-facing switch 113 as shown is coupled to a content delivery server 155, acquisition switch 114, applications switch 117, a client gateway 153, and a terminal server 154 that is operable to provide terminal devices with a connection point to the private network 110. Client gateway 153 may provide subscriber access to private network 110 and the resources coupled thereto.

In some embodiments, STB 121 may access MCDN 100 using information received from client gateway 153. Subscriber devices may access client gateway 153 and client gateway 153 may then allow such devices to access the private network 110 once the devices are authenticated or verified. Similarly, client gateway 153 may prevent unauthorized devices, such as hacker computers or stolen STBs, from accessing the private network 110. Accordingly, in some embodiments, when an STB 121 accesses MCDN 100, client gateway 153 verifies subscriber information by communicating with user store 172 via the private network 110. Client gateway 153 may verify billing information and subscriber status by communicating with an OSS/BSS gateway 167. OSS/BSS gateway 167 may transmit a query to the OSS/BSS server 181 via an OSS/BSS switch 115 that may be connected to a public network 112. Upon client gateway 153 confirming subscriber and/or billing information, client gateway 153 may allow STB 121 access to IPTV content, VOD content, and other services. If client gateway 153 cannot verify subscriber information for STB 121, for example, because it is connected to an unauthorized twisted pair or residential gateway, client gateway 153 may block transmissions to and from STB 121 beyond the private access network 130.

MCDN 100, as depicted, includes application resources 105, which communicate with private network 110 via application switch 117. Application resources 105 as shown include an application server 160 operable to host or otherwise facilitate one or more subscriber applications 165 that may be made available to system subscribers. For example, subscriber applications 165 as shown include an EPG application 163. Subscriber applications 165 may include other applications as well. In addition to subscriber applications 165, application server 160 may host or provide a gateway to operation support systems and/or business support systems. In some embodiments, communication between application server 160 and the applications that it hosts and/or communication between application server 160 and client 120 may be via a conventional web based protocol stack such as HTTP over TCP/IP or HTTP over UDP/IP.

Application server 160 as shown also hosts an application referred to generically as user application 164. User application 164 represents an application that may deliver a value added feature to a subscriber. User application 164 is illustrated in FIG. 1 to emphasize the ability to extend the network's capabilities by implementing a network hosted application. Because the application resides on the network, it generally does not impose any significant requirements or imply any substantial modifications to the client 120 including the STB 121. In some instances, an STB 121 may require knowledge of a network address associated with user application 164, but STB 121 and the other components of client 120 are largely unaffected.

As shown in FIG. 1, a database switch 116 connected to applications switch 117 provides access to database resources 109. Database resources 109 include a database server 170 that manages a system storage resource 172, also referred to herein as user store 172. User store 172, as shown, includes one or more user profiles 174 where each user profile includes account information and may include preferences information that may be retrieved by applications executing on application server 160 including subscriber application 165.

MCDN 100, as shown, includes an OSS/BSS resource 108 including an OSS/BSS switch 115. OSS/BSS switch 115 facilitates communication between OSS/BSS resources 108 via public network 112. The OSS/BSS switch 115 is coupled to an OSS/BSS server 181 that hosts operations support services including remote management via a management server 182. OSS/BSS resources 108 may include a monitor server (not depicted) that monitors network devices within or coupled to MCDN 100 via, for example, a simple network management protocol (SNMP).

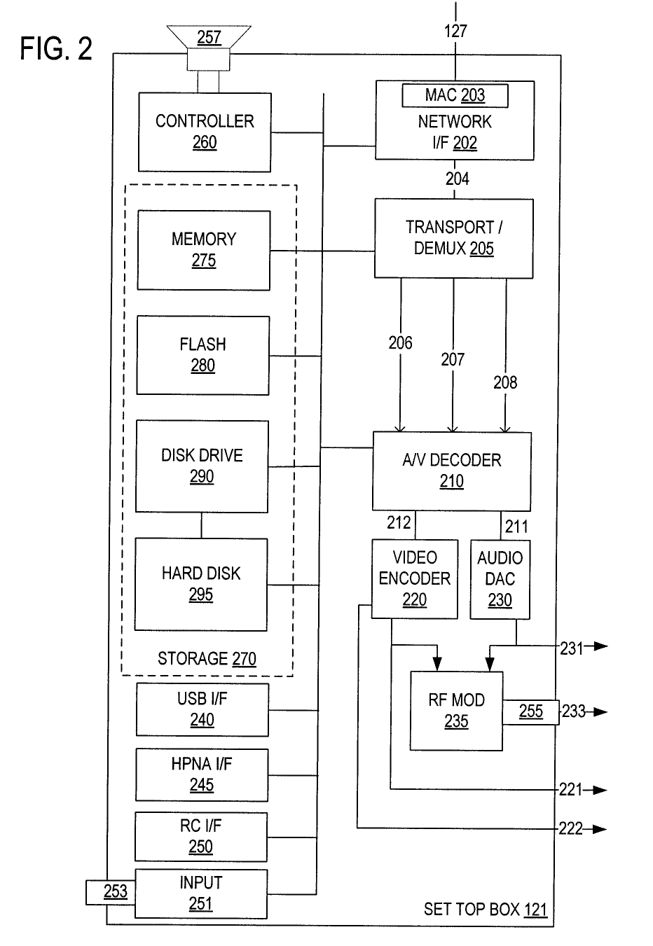

Turning now to FIG. 2, selected components of an embodiment of the STB 121 in the IPTV client 120 of FIG. 1 are illustrated. Regardless of the specific implementation, of which STB 121 as shown in FIG. 2 is but an example, an STB 121 suitable for use in an IPTV client includes hardware and/or software functionality to receive streaming multimedia data from an IP-based network and process the data to produce video and audio signals suitable for delivery to an NTSC, PAL, or other type of display 124. In addition, some embodiments of STB 121 may include resources to store multimedia content locally and resources to play back locally stored multimedia content.

In the embodiment depicted in FIG. 2, STB 121 includes a general purpose processing core represented as controller 260 in communication with various special purpose multimedia modules. These modules may include a transport/de-multiplexer module 205, an A/V decoder 210, a video encoder 220, an audio DAC 230, and an RF modulator 235. Although FIG. 2 depicts each of these modules discretely, STB 121 may be implemented with a system on chip (SOC) device that integrates controller 260 and each of these multimedia modules. In still other embodiments, STB 121 may include an embedded processor serving as controller 260 and at least some of the multimedia modules may be implemented with a general purpose digital signal processor (DSP) and supporting software.

As shown in FIG. 2, output jack 255 is for providing audio signals that, for example, correspond to audio outputs generated by a speech synthesizer which may be embodied at least in part by a software module incorporated into storage 270. In some embodiments, the speech synthesizer produces audio outputs indicative of a portion of a plurality of EPG elements. A screen reader, which also may be incorporated as a software module in storage 270, is for reading the plurality of EPG elements. In some embodiments, the screen reader may be enabled for providing further audio outputs indicative of the location of a cursor on a display. Speaker 257 is for providing audible sounds corresponding to the plurality of audio outputs. Input jack 253 is coupled to input module 251 for receiving audible inputs associated with selected of the plurality of EPG elements. Input jack 253 may be a microphone jack or a may represent a microphone capable of providing audio or electrical outputs corresponding to audio inputs. Data indicative of the audio inputs that is processed by input 251 may be stored in storage 270. In some embodiments, the audio inputs stored in storage 270 may be indexed to selected EPG elements and accessed for including with audio output 233, audio output 231, or another similar signal that provides all or part of a multimedia stream received and processed by STB 121.

Regardless of the implementation details of the multimedia processing hardware, STB 121 as shown in FIG. 2 includes a network interface 202 that enables STB 121 to communicate with an external network such as LAN 127. Network interface 202 may share many characteristics with conventional network interface cards (NICs) used in personal computer platforms. For embodiments in which LAN 127 is an Ethernet LAN, for example, network interface 202 implements level 1 (physical) and level 2 (data link) layers of a standard communication protocol stack by enabling access to the twisted pair or other form of physical network medium and by supporting low level addressing using media access control (MAC) addressing. In these embodiments, every network interface 202 includes, for example, a globally unique 48-bit MAC address 203 stored in a read-only memory (ROM) or other persistent storage element of network interface 202. Similarly, at the other end of the LAN connection 127, RG 122 has a network interface (not depicted) with its own globally unique MAC address.

Network interface 202 may further include or support software or firmware providing one or more complete network communication protocol stacks. Where network interface 202 is tasked with receiving streaming multimedia communications, for example, network interface 202 may include a streaming video protocol stack such as an RTP/UDP stack. In these embodiments, network interface 202 is operable to receive a series of streaming multimedia packets and process them to generate a digital multimedia stream 204 that is provided to transport/demux 205.

The digital multimedia stream 204 is a sequence of digital information that includes interlaced audio data streams and video data streams. The video and audio data contained in digital multimedia stream 204 may be referred to as “in-band” data in reference to a particular frequency bandwidth that such data might have been transmitted in an RF transmission environment. Digital multimedia stream 204 may also include “out-of-band” data which might encompass any type of data that is not audio or video data, but may refer in particular to data that is useful to the provider of an IPTV service. This out-of-band data might include, for example, billing data, decryption data, and data enabling the IPTV service provider to manage IPTV client 120 remotely.

Transport/demux 205 as shown is operable to segregate and possibly decrypt the audio, video, and out-of-band data in digital multimedia stream 204. Transport/demux 205 outputs a digital audio stream 206, a digital video stream 207, and an out-of-band digital stream 208 to A/V decoder 210. Transport/demux 205 may also, in some embodiments, support or communicate with various peripheral interfaces of STB 121 including a radio control (RC) interface 250 suitable for use with an RC remote control unit (not shown) and a front panel interface (not shown). RC interface 250 may also be compatible to receive infrared signals, light signals, laser signals, or other signals from remote controls that use signal types that differ from RC signals. RC interface 250 represents a hardware interface which may be enabled for receiving signals indicative of user inputs. For example, a user may provide user inputs to a remote control device for selecting or highlighting EPG elements on a display.

A/V decoder 210 processes digital audio, video, and out-of-band streams 206, 207, and 208 to produce a native format digital audio stream 211 and a native format digital video stream 212. A/V decoder 210 processing may include decompression of digital audio stream 206 and/or digital video stream 207, which are generally delivered to STB 121 as compressed data streams. In some embodiments, digital audio stream 206 and digital video stream 207 are MPEG compliant streams and, in these embodiments, A/V decoder 210 is an MPEG decoder.

The digital out-of-band stream 208 may include information about or associated with content provided through the audio and video streams. This information may include, for example, the title of a show, start and end times for the show, type or genre of the show, broadcast channel number associated with the show, and so forth. A/V decoder 210 may decode such out-of-band information. MPEG embodiments of A/V decoder 210 support a graphics plane as well as a video plane and at least some of the out-of-band information may be incorporated by A/V decoder 210 into its graphics plane and presented to the display 124, perhaps in response to a signal from a remote control device. The digital out-of-band stream 208 may be a part of an EPG, an interactive program guide (IPG) or an electronic service guide (ESG). Such devices allow a user to navigate, select, and search for content by time, channel, genre, title, and the like. A typical EPG may have a graphical user interface (GUI) which enables the display of program titles and other descriptive information such as program identifiers, a summary of subject matter for programs, names of actors, names of directors, year of production, and the like. In accordance with disclosed embodiments, such EPG data is presented audibly to users. The information may be displayed on a grid and allow a user the option to select a program or the option to select more information regarding a program. A user may make selections, as is commonly known, using input buttons on a remote control. Alternatively, user inputs may be provided by voice-recognition components incorporated into a STB or remote control device, as examples. In some embodiments, users may record customized audio files that may be played audibly during navigation of the STB to allow a user to navigate the EPG without relying on a visual representation of the EPG and associated program identifiers. EPGs may be sent with a broadcast transport stream or on a special data channel. Alternatively, EPGs may be accessed similar to web pages by a web browser or similar software module that retrieves EPG data from a remote web server. In accordance with disclosed embodiments, the components of such EPGs and menu systems are announced audibly to allow those with limited vision or reading skills to obtain data about and select available multimedia events.

The native format digital audio stream 211 as shown in FIG. 2 is routed to an audio digital-to-analog converter (DAC) 230 to produce an audio output signal 231. The native format digital video stream 212 is routed to an NTSC/PAL or other suitable video encoder 220, which generates digital video output signals suitable for presentation to an NTSC or PAL compliant display device 124. In the depicted embodiment, for example, video encoder 220 generates a composite video output signal 221 and an S video output signal 222. An RF modulator 235 receives the audio and composite video outputs signals 231 and 221 respectively and generates an RF output signal 233 suitable for providing to an analog input of display 124. Additionally output jack 255 may be used to plug in a headset for providing audio signals. Such audio signals may contain audio signals indicative of audio outputs generated by a speech synthesizer that are combined with audio signals associated with multimedia content such as a movie. In this way, a user may receive audio signals that correspond to an audible menu system (e.g., audible announcements of EPG elements).

In addition to the multimedia modules described, STB 121 as shown includes various peripheral interfaces. STB 121 as shown includes, for example, a Universal Serial Bus (USB) interface 240 and a local interconnection interface 245. Local interconnection interface 245 may, in some embodiments, support the HPNA or other form of local interconnection 123 shown in FIG. 1.

The illustrated embodiment of STB 121 includes storage 270 that is accessible to controller 260 and possibly one or more of the multimedia modules. Storage 270 may include dynamic random access memory (DRAM) or another type of volatile storage identified as memory 275 as well as various forms of persistent or nonvolatile storage including flash memory 280 and/or other suitable types of persistent memory devices including ROMs, erasable programmable read-only memory (EPROMs), and electrically erasable programmable read-only memory (EEPROMs). In addition, the depicted embodiment of STB 121 includes a mass storage device in the form of one or more magnetic hard disks 295 supported by an integrated device electronics (IDE) compliant or other type of disk drive 290. Embodiments of STB 121 employing mass storage devices may be operable to store content locally and play back stored content when desired.

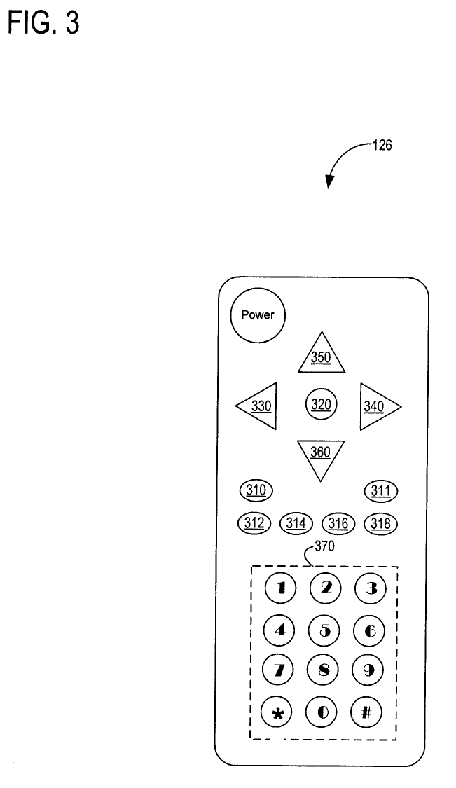

FIG. 3 illustrates an exemplary remote control device 126 suitable for use with STB 121. The functionality of remote control device 126 is described to illustrate basic functionality and is not intended to limit other possible functionality that may be incorporated into other embodiments. For example, although not shown, the buttons or indicators of remote control device 126 may include a button, a knob, or a wheel for receiving input.

In the embodiment depicted in FIG. 3, remote control device 126 has various function buttons 310, 311, 312, 314, 316, and 318, a “select” button 320, a “backward” or left-ward button 330, a “forward” or right-ward button 340, an “upward” button 350, and a “downward” button 360. The number, shape, and positioning of buttons 310 through 360 is an illustrative implementation detail but other embodiments may employ more or fewer buttons of the same or different shapes arranged in a similar or dissimilar pattern. The “select” button 320 may be used to request a channel to be viewed on the full display to the exclusion of other icons, menus, thumbnails, line-ups and/or other items. Button 320 may additionally be considered an “Enter” button or an “OK” button. Keypad 370, as shown, is a numeric keypad that permits a user an option of selecting channels by entering numbers as is well known. In other embodiments, keypad 370 may be an alphanumeric keypad including a full or partially full set of alphabetic keys. In conjunction with an audible menu system described below, one or more of the function buttons 310 through 318 may be used to provide user inputs for selecting EPG elements (e.g., selectable icons, program identifiers, and text boxes).

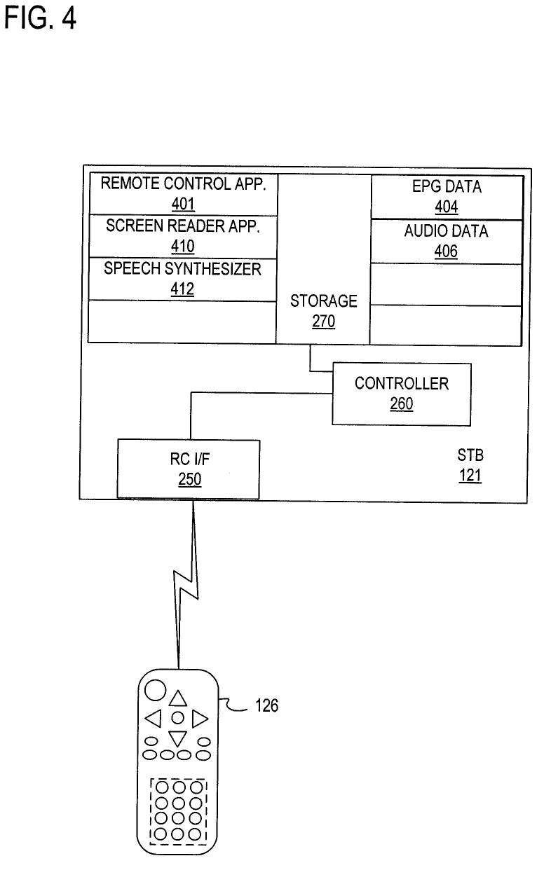

Turning now to FIG. 4, selected software elements of an STB 121 operable to support an audible menu system are illustrated. In the depicted implementation, the storage 270 of STB 121 includes a program or execution module identified as remote control application 401 and a module identified as screen reader application 410. In addition, the depicted implementation of storage 270 includes data objects identified as EPG data 404 and audio data 406.

Remote control application 401 includes computer executable code that supports the STB 121's remote control functionality. For example, when a user depresses a volume button on remote control device 126, remote control application 401 includes code to modify the volume signal being generated by STB 121. In some embodiments, remote control application 401 is invoked by controller 260 in response to a signal from RC interface 250 indicating that RC interface 250 has received a remote control command signal. Although the embodiments described herein employ a wireless remote control device 126 to convey user commands to STB 121, the user commands may be conveyed to STB 121 in other ways. For example, STB 121 may include a front panel having function buttons that are associated with various commands, some of which may coincide with commands associated with function buttons on remote control device 126. Similarly, although remote control device 126 is described herein as being an RF or IR remote control device, other embodiments may use other media and/or protocols to convey commands to STB 121. For example, remote control commands may be conveyed to STB 121 via USB, WiFi (IEEE 802.11-family protocols), and/or Bluetooth techniques, all of which are well known in the field of network communications.

RC interface 250 may be operable to parse or otherwise extract the remote control command that is included in the signal. The remote control command may then be made available to controller 260 and/or remote control application 401. In this manner, remote control application 401 may receive an indication of the remote control command from the RC interface 250 directly or from controller 260. In the latter case, for example, controller 260 might call remote control application 401 as a function call and include an indication of remote control device 126 as a parameter in the function call.

STB 121, as shown in FIG. 4, also includes screen reader application 410 that may work in conjunction with remote control application 401. In some embodiments, STB 121 is operable to receive directional input signals to make a cursor displayed in a GUI to highlight or select EPG elements. Speech synthesizer 412 provides for the artificial production of human-like speech. In operation, screen reader application 410 may read elements of a display-based EPG and provide outputs to speech synthesizer 412 for the production of sounds that correspond to elements within the EPG. Speech synthesizer 412 may create audio outputs corresponding to EPG elements using concatenated pieces of recorded speech that may be prerecorded and provided with STB 121. Alternatively, a user may provide audio outputs for inclusion with stored data used by speech synthesizer 412. In some embodiments, speech synthesizer 412 may perform linguistics analysis to outputs from screen reader application 410 to provide more life-like audio outputs.

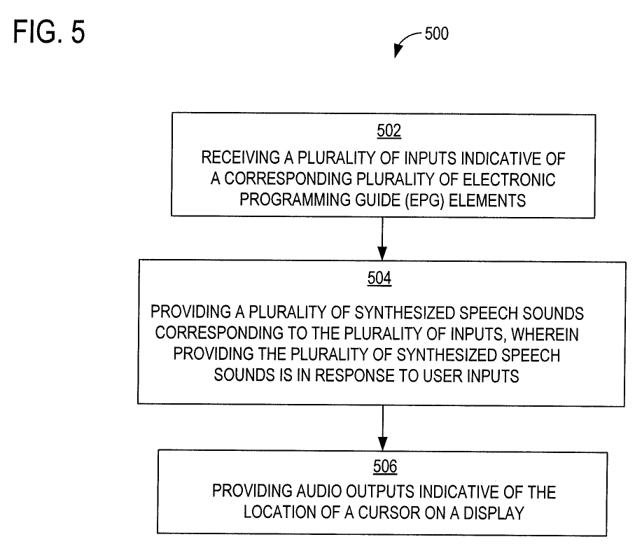

Referring now to FIG. 5, operations of methodology 500 are illustrated. Operation 502 relates to receiving a plurality of inputs indicative of a corresponding plurality of EPG elements. For example, screen reader application 410 (FIG. 4) may receive, by reading a screen image from a GUI, several inputs that relate to program identifiers for available programming. As shown, operation 504 relates to providing a plurality of synthesized speech sounds corresponding to the plurality of inputs. Providing the plurality of synthesized speech sounds is in response to user inputs. For example, if a user employs a remote control device (e.g., remote control device 126 from FIG. 1) to provide directional inputs for “moving” a cursor over selectable icons shown on a GUI viewable on display 124-2, in accordance with methodology 500 one or more software and hardware modules operating within STB 121 may provide audible announcements corresponding to items that are selectable by the cursor. As shown, operation 506 relates to providing audio outputs indicative of the location of the cursor on a display. It is noted, however, that because disclosed embodiments relate to audible menu systems, it is unnecessary for any GUI to be presented on display 124. Further, no display is necessary for operation of disclosed embodiments.

Disclosed embodiments provide audio announced menu systems that may be run from a STB or data processing system coupled to a STB for assisting those that are visually impaired, for example, with selecting available multimedia content. In addition, disclosed embodiments may assist a visually impaired person with configuring settings related to a STB, user account, or television, as examples.

In some STB operating systems, a command line interface may be employed in which characters are mapped directly to a screen buffer in memory. On-screen cursor position may be determined using inputs from a keyboard or from buttons found on a remote control unit. Menu text may be obtained by intercepting or copying the flow of EPG information used in displaying the EPG on a display. In addition, the screen buffer may be access to obtain text that is for displaying as part of the EPG.

GUI screen readers may be more complicated than command line interface for screen readers. A GUI typically has characters and graphical symbols (e.g., selectable icons) generated on a display at particular positions. To a STB or other data processing system, such GUIs may consist of pixels on a screen with that have no particular form. As such, from the point of view of a STB that receives an EPG for display, there may be only limited, if any, textual representations or discrete graphical representations on a display. Therefore some embodied systems may be required to perform optical character recognition (OCR) and other recognition techniques to identify text and selectable icons, as examples.

Alternatively, EPG data may be sent from a provider network to an embodied STB with commands that can be read and interpreted by the STB. For example, instructions for drawing text and command buttons may be intercepted and used to construct an off-screen model that is analyzed and used to extract program identifiers, controls, and menu commands that are sent to a text-to-speech model for announcing audibly. As a user provides directional input, for example, to switch EPG elements, disclosed embodiments provide audible announcements indicative of which EPG element is highlighted or selected.

In other disclosed embodiments, maintaining off-screen models is not necessary. For example, some embodiments provide access through standard application programming interfaces (APIs) to indications of what is simultaneously displayed on a screen. Accordingly, in some embodiments, menu systems sent from a provider network are formatted for compatibility with one or more speech APIs (SAPIs). Such SAPIs allow speech recognition and speech synthesis for menu-based systems that may be used by disclosed STBs. Herein, screen reader and speech synthesizer technologies and methods are assumed to be known and particular details are omitted for clarity. Screen readers can query the operating system or application for what is currently being displayed and receive updates when the display changes. For example, a screen reader can be told that the current focus is on a button and the button caption may be communicated to the user.

While the disclosed systems may be described in connection with one or more embodiments, it is not intended to limit the subject matter of the claims to the particular forms set forth. On the contrary, it is intended to cover such alternatives, modifications and equivalents as may be included within the spirit and scope of the subject matter as defined by the appended claims.

What is claimed is:

1. A set-top box for providing an audible menu system, the set-top box comprising:
a screen reader for reading a plurality of electronic programming guide elements; and
a speech synthesizer for providing a plurality of audio outputs indicative of a portion of the plurality of electronic programming guide elements.

2. The set-top box of claim 1, wherein the screen reader is enabled for providing further audio outputs indicative of the location of a cursor on a display.

3. The set-top box of claim 2, further comprising:
an output jack for providing audio signals based on the audio outputs.

4. The set-top box of claim 3, further comprising:
an input jack for receiving audible inputs for associating with selected of the plurality of electronic programming guide elements; and
a memory for storing data indicative of the audible inputs.

5. The set-top box of claim 1, further comprising:
a speaker for providing audible sounds corresponding to the plurality of audio outputs.

6. The set-top box of claim 1, wherein the set-top box is enabled for including the plurality of audio outputs with an audio portion of a multimedia stream received from a provider network.

7. The set-top box of claim 6, further comprising:
a hardware interface for receiving signals indicative of user inputs.

8. The set-top box of claim 7, wherein the set-top box is further enabled for announcing the user inputs received by the set-top box from the hardware interface.

9. A computer program product stored on one or more computer readable media for providing an audible menu system, the computer program product comprising instructions operable for:
receiving a plurality of inputs indicative of electronic programming guide elements; and
providing a plurality of synthesized speech sounds corresponding to the plurality of inputs in response to receiving the inputs.

10. The computer program product of claim 9, wherein the user inputs are provided to audibly verify the position of a cursor over a selectable icon.

11. The computer program product of claim 10, wherein the selectable icon is a text box containing a program identifier.

12. The computer program product of claim 9, further comprising instructions for:
providing audio outputs indicative of the location of a cursor on a display.

13. The computer program product of claim 12, further comprising instructions for:
storing data indicative of received audible inputs; and
associating a portion of the data with selected of the electronic programming guide elements.

14. A method of providing an audible menu system, the method comprising:
receiving a plurality of inputs indicative of electronic programming guide elements; and
providing a plurality of synthesized speech sounds corresponding to the plurality of inputs in response to user inputs.

15. The method of claim 14, wherein the user inputs are provided to verify the position of a cursor over a selectable icon.

16. The method of claim 15, wherein the selectable icon is a text box containing a program identifier.

17. The method of claim 14, further comprising:
providing audio outputs indicative of the location of a cursor on a display.

18. The method of claim 17, further comprising:
encoding audio signals corresponding to the plurality of inputs, wherein the audio signals are for providing to an output jack.

19. The method of claim 18, further comprising:
storing data indicative of received audible inputs; and
associating a portion of the data with selected of the electronic programming guide elements.

20. The method of claim 19, further comprising:
combining the plurality of synthesized speech sounds with the audio portion of a multimedia stream.
